(19) United States
(12) Patent Application Publication
(10) Pub. No.: US 2003/0072685 A1
(43) Pub. Date: Apr. 17, 2003

(54) Heat conducting sample block

(76) Inventors: Jeffrey A. Goldman, Acton, MA (US); Michael J. Denninger, Maynard, MA (US); Michael J. Griffin, Brighton, MA (US)

Correspondence Address: CLARK & ELBING LLP, 101 FEDERAL STREET, BOSTON, MA, 02110, US

(21) Appl. No.: 09/975,878

(22) Filed: Oct. 11, 2001

(51) Int. Cl. B01L 3/00

(52) U.S. Cl. 422/102; 422/104; 422/942; 422/943; 435/288.4

(57) ABSTRACT

Disclosed herein is a heat-conducting sample block that includes a top plate and a base plate, each having upper and lower faces, the upper face of the top plate having a recess therein. The recess has an opening for accepting a sample or sample vessel, and the lower face of the top plate has a projection extending towards and fixedly engaged with a notch on the upper face of the base plate.

### BACKGROUND OF THE INVENTION

This invention relates to heat conducting sample blocks for use in the controlled heating and cooling of reaction vessels. In particular, the invention relates to a heat conducting sample block for use in an instrument for controlling biochemical and biological molecular processes, such as cycle sequencing and polymerase chain reactions (PCR).

Systems that require multiple or cyclic chemical reactions to produce a desired product often require careful temperature control to produce optimal results. For this reason, instruments have been developed that permit the accurate control of the temperature in reaction vessels in which such reactions are to be performed. Important examples of such reactions include PCR and cycle sequencing.

PCR and cycle sequencing require thermal cycling, that is, changing temperature in alternating steps to allow melting of deoxyribonucleic acid (DNA), annealing of short primers to the resulting single strands, and extending those primers to make new copies of double-stranded DNA. In thermal cycling, the reaction mixture is repeatedly cycled from high temperatures of around 90° C. to 95° C. for melting the DNA, to lower temperatures of approximately 40° C. to 70° C. for primer annealing and extension. Generally it is desirable to change the sample temperatures as rapidly as possible. The chemical reaction has an optimum temperature for each of its stages, and the less time spent attaining the optimum temperature the better. Reducing the time spent at non-optimum temperatures reduces the time required for a complete cycle and can improve the quality of the reaction product.

In some prior thermal cyclers, sample vessels are inserted into sample wells in a metal block. As the metal block is heated and cooled, the samples experience similar changes in temperature. However, temperature gradients can arise in the metal block, thereby causing some samples to experience different temperatures at particular times in the cycle.

In the construction of some prior thermal cyclers, uniaxial pressure is applied to maintain contact of the metal block with the heating and cooling apparatus of the thermal cycler. This pressure can lead to block distortion and deterioration of the structural integrity of the sample block.

PCT International Published Application WO 93/09486 describes metal blocks prepared by electroforming a single continuous layer of metal. The block contains recesses into which reaction tubes are inserted and the recesses form projections on the underneath of the block. While electroforming provides advantages over a block made up of components joined by solder (which can disrupt heat conduction) and is less costly and time-consuming than machining the sample wells into a solid metal block, the low mechanical strength and limited lateral heat conduction of the thin metal sheet result in a less-than-optimal product.

PCT International Published Application WO 98/43740 describes a metal block using a single continuous layer of metal fastened to a base plate. The base plate is intended to improve lateral heat conduction; however, the publication notes that the problem of uniform heating remains.

Minimizing non-uniformity in temperature at various points on the sample block and reducing the time required for and delays in heat transfer to and from the sample are of great importance to optimizing PCR and cycle sequencing. In addition, improving mechanical strength and structural integrity of the metal block remain important goals in order to provide a robust and sturdy heat-conducting sample block.

### SUMMARY OF THE INVENTION

A heat conducting sample block with low heat capacity, high thermal conductivity, and good mechanical strength is provided. The sample block is a multi-component system including a top plate having the features necessary for reaction vessel insertion and a base plate which acts as a structural member and as an interface to the heating and cooling sources.

According to the invention, a heat conducting sample block includes a top plate and a base plate. The top plate contains at least one recess having an opening on the upper face of the plate for accepting a sample or sample vessel, and at least one corresponding projection on its lower face. The base plate also contains an upper face and a lower face, and the upper face includes at least one notch that is fixedly engaged with a corresponding projection of the top plate.

The sample block of the invention possesses many advantages over prior art sample blocks. The use of a base plate provides greater mechanical strength, dimensional stability, and lateral thermal conduction. The notch, which engages and surrounds the lower portion of the projection increases the surface area of contact between the top plate that holds the sample and the base plate that contacts the heating and cooling apparatus of the thermal cycler, thereby improving the efficiency of the heat transfer between the heating and cooling apparatus and the samples. The method of assembly of the sample block also provides advantages over prior art methods. The sample block may be assembled from components manufactured by standard processes; and minimal post assembly machining is required. Common soldering materials and manufacturing techniques may be employed. Significantly, the system is self-aligning due to the engagement of the top plate projections with the notches of the base plate, which significantly simplifies manufacture.

### BRIEF DESCRIPTION OF THE DRAWINGS

The invention is described with reference to the figures, which are presented for illustration purposes only, and which are not intended to be limiting of the invention, and in which:

FIG. 1 is a perspective illustration of one embodiment of the heat conducting sample block of the invention (for simplicity, an 8×6 well sample block is shown);

FIG. 2 is a cross-sectional view of the sample block of FIG. 1;

FIGS. 3A-3E illustrate exemplary geometries for the tapered cylinder recesses of the sample block;

FIG. 4 is a cross-sectional view of a sample block using a one-layer base plate;

FIG. 5 is a cross-sectional view of a sample block using a two-layer base plate; and

FIG. 6 is a cross-sectional view of a sample block using a three-layer base plate.

### DETAILED DESCRIPTION OF THE INVENTION

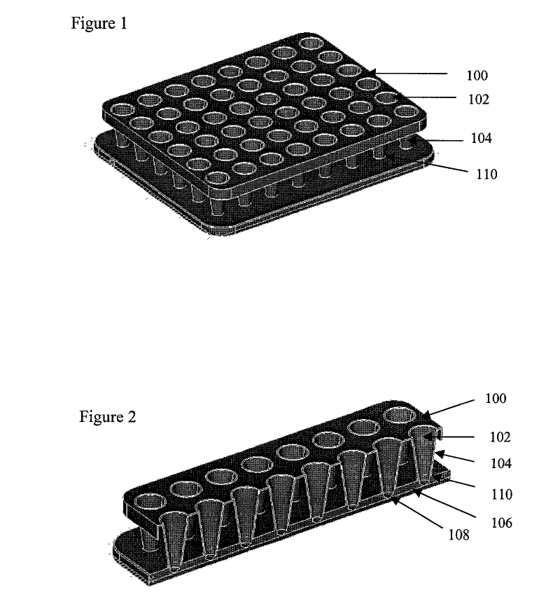

The sample block of the invention is a multi-component system including a top plate having the features necessary for reaction vessel insertion and a base plate, which acts as a structural member and as an interface to the heating and cooling sources. The sample block provides improved thermal performance, increased mechanical strength, and ease of assembly. An exemplary sample block is shown in perspective in FIG. 1 and in cross-section in FIG. 2. For simplicity, an 8×6 sample block is shown; however, it is appreciated that the block may include any number, arrangement, and size of sample wells.

A top plate 100 similar to those currently used in the industry may be employed (see, for example, WO 93/09486; WO 98/43740). The top plate includes one or more recesses 102 into which reaction sample vessels (not shown) may be inserted. The recesses define downwardly projecting features (“projections”) 104. The arrangement of the recesses may conform to industry standards, such as the standard 96-well microplate (126 mm×86 mm nominal) in which sample wells are arranged in a square grid on 9 mm centers. Other arrangements are within the scope of the invention, such as a greater or smaller number of sample recesses (for example, a 384-well configuration) or recesses adapted to accommodate glass slides.

A base plate 106 includes one or more notches 108, as is shown in cross-section in FIG. 2. The notches 108 are located in the base plate 106 so as to be in alignment with the projections 104 of the top plate 100. The projections are permanently engaged, e.g., “fixed”, in the notches. The top and base plates may be joined using conventional means, such as solder or brazing materials, which flows by capillary action into any voids or gaps between the two components to form a permanent seal 110.

In some embodiments, the projections may have an interference fit with the notches, such that a seal is made between the top and base plates. In some embodiments, the projections may have a clearance fit with the notches, such that a notch is larger than a projection with both parts made to their maximum material condition. Either of these embodiments results in a sample block for which a high degree of alignment between the top and base plates is automatically attained. In other embodiments, the notch may be oversized so that a space or gap is formed around the projection. The space or gap is filled or substantially filled with sealing material in the finished article.

The sample block optionally includes a mechanical fastener in its lower face for securing the block to heating and cooling sources. The mechanical fastener may be a retaining screw, threaded channel, or any other equivalent means for providing a downward pressure on the sample block.

The top plate 100 is made of a continuous metal of the desired shape. The shape may be accomplished using conventional metal processing techniques, such as electroforming, drawing, machining, molten metal casting, and molding.

Electroforming is a preferred method due to the ease of manufacturing and design flexibility. It is a reliable method of providing the top plate with regards to thermal performance, structural integrity, esthetics, and cost. An electroformed part provides a single, fine silver surface with the desired net shape. In addition to providing an accurate fit for the sample reaction vessels, it has an aesthetically pleasing appearance. The lower surface of the electroform is defined by the lower surface of the projections. It acts as the interface to the base plate system and requires dimensional stability.

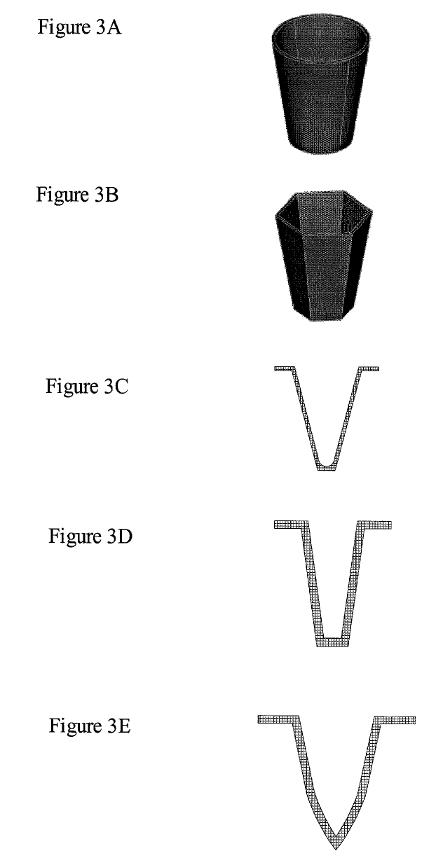

The recess of the top plate may be in the general form of a cone, so that the mouth of the cavity is larger than its base, as shown in FIG. 3. This shape is particularly useful for sample reaction vessels. Alternately, recesses may have walls with non-straight cross sections (FIG. 3A), or that are faceted to provide an overall cylindrical shape (FIG. 3B). Typically, recesses have the form of cones that taper to rounded or flattened ends (FIGS. 3C and 3D, respectively), although cones that taper to pointed ends are possible (FIG. 3E). Inner and outer surfaces may differ in shape. For example, the inner surface may be rounded, whereas the outer surface has a flattened end (FIG. 3C). The recesses may be of any appropriate size; for example, they may be configured to accept 0.1 ml, 0.2 ml or 0.5 ml sample tubes, and may be configured in any array.

The top plate 100 may be prepared from materials that have good heat conductance, so that heat from a heat source may be efficiently transferred to a sample contained within the recesses of the block. Exemplary materials include aluminum and silver, including silver alloys. In preferred embodiments, the top plate is made up of fine silver. The plate may also be a composite material, in which silver or silver alloy is used as the base and a second layer is deposited thereon. In one embodiment, a silver-copper composite is contemplated in which a copper layer is electroplated over an electroformed plate. Copper has good heat conductance, protects the surface of the silver and reduces the amount of silver required.

The base plate 106 also is made from materials having high thermal conductivity, such as aluminum, silver, and silver alloys. In one embodiment, the base plate is made from a composite material consisting of a pyrolytic graphite fiber weave encapsulated in aluminum (available as TC1050 from Advanced Ceramics, Lakewood, Ohio, USA); other metals can be used as the encapsulant, such as copper and silver. If aluminum is used, the base may be plated with nickel to facilitate bonding to solder. In preferred embodiments, the base plate is made up of silver, and in particular sterling silver.

The base plate 106 includes one or more notches 108 that can be of any geometry, so long as they are capable of accommodating the projections of the top plate. The notches may be machined, bored, drilled, or otherwise introduced into the base plate; or they may be formed by alignment of holes that have been punched, pressed, drilled, or otherwise formed in a plurality of metal layers, as is described herein below. Notches may be triangular, rectangular, square, round, or oval in cross-section. They may have parallel or tapered sidewalls, or include an undercut or beveled edge. Notches having circular cross-sections are typically the result of boring or drilling, whereas notches having triangular, square, or rectangular cross-section are more likely to result when notches of the lower plate are formed by stamping.

The base plate can be made up of one or more layers; and those layers can be thick or thin. Multiple layers include laminates or thick or thin sheets having a bond line between them. The multiple layers of the base plate are securely joined in a manner that can withstand the heat and pressures of operation and assembly. Most conventional methods of bonding may be applied. For example, the multiple layers of the base plate may be joined by soldering, brazing, gluing using bonding materials such as epoxy, fusing, welding, or high temperature diffusion bonding. By using more than one layer, different structure and functionality can be introduced into the base plate. For example, it is possible to form void spaces within the base plate to form mechanical joints that improve the strain tolerance on the joint and/or demonstrate improvements in thermal conductivity and heating. A laminate may have different mechanical strength characteristics different from those of a monolith layer. If a weak material is incorporated in the base (such as TC1050 discussed above) then it may be necessary to add structural supports that distribute any externally applied stress across the base.

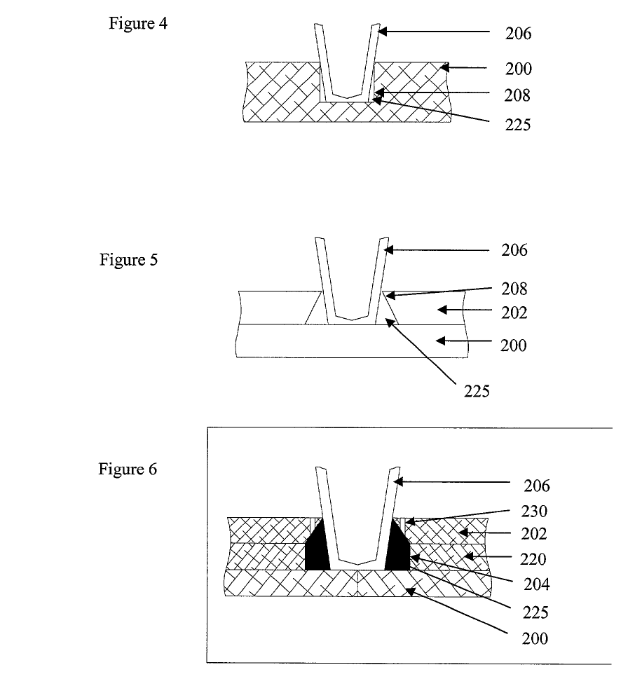

FIGS. 4, 5, and 6 are cross-sectional illustrations of exemplary sample blocks using a one-layer, two-layer and three-layer base plate, respectively. The sample blocks include a solid base layer 200. The multilayer base plate also contains a perforated base layer 202 having an aperture 204 therein. A cone or projection 206 of the upper plate passes through the aperture and contacts the solid base plate 200. The aperture may have parallel, tapered, or undercut walls. The solid base plate may be flat, i.e., featureless, or it may contain a recessed portion 208 for receiving the base of the projection or cone 206 that is inserted therein. The three-layer base plate of FIG. 6 additionally includes an intermediate base layer 220. It should be apparent that any number of intermediate layers of varying thicknesses may be used. A laminate structure employing many thin sheets, each sheet having the appropriate aperture pattern, is contemplated. The laminar sheets may be stacked (with blank sheets at the base to form a solid base layer), with bonding agent, such solder or adhesive, applied between each sheet. The sheet/adhesive composite is pressed or stamped to form the laminate structure.

An advantage of a multilayer base plate is that complicated geometries for the notch may be easily constructed. The truncated conical or pyramidal undercuts shown in FIGS. 5 and 6 would be very hard to machine from a solid metal sheet, but are readily formed by assembly of individual layers using conventional techniques. For example, a chamfer tool is capable of creating a beveled aperture in the upper base layer, which may be combined with parallel-walled perforated layers and solid base layers to form any conceivable notch design.

As is seen in the figures, the use of beveled perforated base layers gives rise to a cavity 225 within the base layer. In some embodiments, the cavity is filled, or substantially filled, with a bonding material that joins the top and base plates. In order to facilitate the filling of the cavities with solder, the sample block may include channels 230, which intersect with the void space 225. The channels allow for venting of gaseous by-products during assembly of the sample, e.g., flux and binder, and permits capillary flow of molten solder into the void space.

In a preferred embodiment, a low melting solder or a brazing material is used. Low melting solder is preferred because it is possible to melt and infuse the cavity with solder at temperatures below the anneal temperatures of the top and base plates. The solder may also be selected for its thermal heat capacity. If a solder having a heat capacity less than that of the base plate is selected, the solder will heat up faster than the base plate. Based on transient heat-up of convective-loss systems, the recesses are expected to heat up faster than the bulk base plate, thereby enhancing the ramp rate in both heating and cooling for the recesses.

In the embodiments described herein, the notch and solder seal surround the lower portion of the cones of the top plate. This results in a larger contact surface area when compared to soldering the projection base to a notch-less plate. The advantage of increased contact surface area manifests itself in greater thermal ramp rates and reduced cycling times.

In those embodiments for which a conical undercut is employed, a large volume of solder is in contact with the projection base. Even greater improvements in thermal cycling may be expected. In addition, a mechanical joint is created in those instances where a conical undercut is used. The forces imparted on the cone/base plate are distributed to the upper plate over a greater area, which reduces the stress on the joint.

The heat conducting sample block may be incorporated into a thermal cycling device. The thermal cycler typically includes heating and cooling elements in thermal contact with the sample block, and a means for switching between the heating and cooling elements. These devices are well known in the art.

The invention is now further illustrated by the following non-limiting examples.

### EXAMPLE 1

This example describes the manufacture and assembly of a heat conducting sample block having a single part base plate. The sample block is a two part silver-soldered assembly. The parts consist of a silver electroformed top plate that contains the features for reaction tube insertion and a one part base plate, which interfaces to the heat/cool devices.

A 96-well, electroformed top plate was used in the assembly of the sample block. The wells project downwardly to form tapered cylindrical cones. The electroform part had two machining operations after forming. The first was machining the edge for flash removal. The second was flycutting the outer tips of all the cones for parallelism to the top surface and flatness of the cones for interface with the base plate.

The base plate is constructed from rolled stock as per the following description. The plate is a 3.0 mm thick plate of ¾ hard sterling silver with an array of ninety-six 4.5 mm diameter counterbore shaped notches which match the top plate array spacing (9.0 mm on center in X and Y). Mass reduction counterbores (77 @4.75 mm) are milled at interstitial locations with respect to the well holes. All holes are milled to a depth of ⅔ of the total thickness of the plate.

The solder used for the silver sample block is 96/4 eutectic, which is an alloy of 96% Sn, 4% Ag with a liquidus/solidus point of 221 degrees Celsius. This solder has high strength and more importantly has sufficient creep resistance necessary for the temperature and stress levels during operation. A two stage soldering process is used to attach the top plate and base plate using an actively controlled hot plate. The 96 well holes are either screened or injected with 96/4-K2 paste (70% metal, balance is flux and binder). The base plate is heated with no top plate to flow the solder in the interior of the counterbore. A second application of solder is added to the well holes and the top plate is inserted to a point, which the lower portions of the cones are in contact with the previously solidified solder. The heat cycle is repeated allowing the top plate to sink into the solder and contact the bottom of the counterbores. The solder is forced out of the hole leaving a fillet between the cone and the upper surface of the base plate. The second cycle is performed between a pair of spring loaded platens which have sufficient travel to accommodate the top plate movement. No location fixturing is necessary since the base plate holes themselves act to align the electroform top plate.

A final machining step includes a flycutting process of the base plate for flatness, milling sensor holes, and trimming the edge of the base plate for alignment to the top plate. The block is then cleaned using an ultrasonic cleaner to remove excess flux and binder in preparation for an electroless nickel plating process.

### EXAMPLE 2

This example describes the manufacture and assembly of a heat conducting sample block having a top plate as described in Example 1 and multi-part base plate.

The base plate is constructed from rolled stock in a laminated process of silver sheet and silver solder as per the following description. The base plate is ¾ hard sterling silver with backside chamfered holes created by increasing the hole diameter for each sheet from the top down. The array of ninety-six 4.5 mm diameter counterbores of Example 1 now becomes a 4.5 mm starting diameter and a 5.0 mm ending diameter at a depth of ⅔ of the total base plate thickness. This is done to create a greater solder volume and is found to improve thermal and structural performance. The remaining ⅓ of the plates are blanks. The individual sheet thickness varies but is selected to create the finished 2.8 mm total thickness and maintain the ⅔ hole depth. Mass reduction counter bores (77@4.75 mm) are created by constant diameter holes at interstitial locations with respect to the well holes.

The solder used for the silver sample block is 96/4 eutectic, which is an alloy of 96% Sn, 4% Ag with a liquidus/solidus point of 221 degrees Celsius. A single stage soldering process is used to attach the top plate and base plate stack using an actively controlled hot plate. Each sheet of the base plate stack is screened with solder paste to apply solder specific locations. The top plate has solder rings installed over each cone and is inserted into the base plate stack. This assembly is heated to 240 degrees Celcius between spring loaded platens (F=400 lbs) to solder the system together. No final machining step is needed as the base plate sheets conform to the 0.03 mm flatness of the platens. Sensor holes are created by a similar technique of cutouts on individual sheets, which create the feature upon assembly. These may require a clean-up step to clear excess solder.

The block is then cleaned using an ultrasonic cleaner to remove excess flux and binder in preparation for an electroless nickel plating process.

Other embodiments are within the claims.

We claim:

1. A heat conducting sample block comprising a top plate and a base plate, each having upper and lower faces; the upper face of the top plate having a recess therein, said recess having an opening for accepting a sample or sample vessel, and the lower face of the top plate having a projection extending towards and fixedly engaged with a notch on the upper face of the base plate.

2. The heat conducting sample block of claim 1, wherein said base plate is comprised of multiple layers, whereby said multiple layers are configured to provide said notch.

3. The heat conducting sample block of claim 2, wherein said notch is undercut.

4. The heat conducting sample block of claim 1, 2, or 3, wherein said notch has an interior volume surrounding said projection, and said interior volume contains a material having a heat capacity lower than the heat capacity of the base plate.

5. The heat conducting sample block of claim 1, 2, or 3, wherein the block comprises at least two recesses and at least two notches, whereby x-y registration of the top plate and the base plate is achieved.

6. The heat conducting sample block of claim 1, wherein at least one of said top plate or said base plate is comprised of silver, silver alloy, or silver composites.

7. The heat conducting sample block of claim 1, wherein said base plate further comprises a mechanical fastener on its lower face.

8. A heat conducting sample block comprising a top plate and a base plate, wherein said base plate is a composite made up of a graphite fiber weave and an encapsulant.
